(19) United States
(12) Patent Application Publication
(10) Pub. No.: US 2009/0260084 A1
(43) Pub. Date: Oct. 15, 2009

(54) METHOD FOR VERIFYING CONFORMITY OF THE LOGICAL CONTENT OF A COMPUTER APPLIANCE WITH A REFERENCE CONTENT

(75) Inventor: David Naccache, Paris (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Ingenico, Neuilly Sur Seine (FR)

(21) Appl. No.: 12/280,438

(22) PCT Filed: Feb. 27, 2007
(86) PCT No.: PCT/FR07/00351

§ 371 Date: May 6, 2009

(30) Foreign Application Priority Data
Mar. 1, 2006 (EP) 062903455
Aug. 25, 2006 (EP) 060177417

(51) Int. Cl. G06F 21/00; G06F 21/24; G06F 7/10

(52) U.S. Cl. 726/23

(57) ABSTRACT

A computer appliance and method are provided. The computer appliance includes a processor, a memory in which the processor can read and write, and an input/output device for interfacing the appliance processor with the outside world. In order to verify conformity of the logical content of the appliance with the reference content, the method includes sending to the appliance a request for loading into the memory and executing a verification program. The verification program is capable or writing data into the memory of the appliance and of reading data in the memory to send them to the input/output device. Then, the method includes sending to the appliance a request for executing the program to saturate the memory available not taken up by the program. Finally, it includes exchanging messages with the appliance by executing the program. Based on the exchanged messages, the conformity of the logical content of the appliance is verified.

### CROSS-REFERENCE TO RELATED APPLICATIONS

This application is a Section 371 National Stage Application of International Application No. PCT/FR2007/000351, filed Feb. 27, 2007 and published as WO 2007/099224 on Sep. 7, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to computer appliances and more specifically to verifying the conformity of the logical content of a computer appliance with a reference content.

### BACKGROUND OF THE DISCLOSURE

The term computer appliance is used for an information processing appliance that comprises a processor associated with a storage memory, and input/output devices. The processor, the memory, and the input/output devices may be implemented in accordance with different hardware solutions. The memory may thus include for example an EEPROM, EPROM type memory or a Flash memory. The appliance is capable of loading into the processor a program or software contained in the memory, and of executing the program or software. The appliance is capable of communicating with the outside world through the input/output devices, in order to receive information from the outside world or transmit information to the outside world. Included in this definition of a computer appliance are smart cards, payment terminals, personal digital assistants (PDA), pay television terminals, and computers. These appliances differ by processor type, memory type, input/output device type and by their destination.

For an appliance of this type, the term logical content or logic state is used for the memory content—whether this involves executable code, parameters or passive data.

One problem encountered in respect of computer appliances is that of the conformity of the appliance's logical content with a reference content. This problem arises when dealing with an appliance with known hardware specifications, in particular the size of the memory and the type of processor. The problem lies in knowing whether the appliance being dealt with is in a reference state. The reference state may correspond to a given logical content—certain information present in the memory—or to an absence of information in the memory.

This problem arises in particular in respect of smart cards and payment terminals; indeed, information of a confidential nature is written in the memories of these appliances.

The customisation of smart cards (for GSM standard telephone applications, payment or identity) and payment terminals comprises a phase of injecting executable code into these appliances. Typically, smart cards with open operating systems (like those sold as conforming to the “Javacard” standard) allow executable programs or extensions to be added to the card's non-volatile memory (typically EEPROM, EPROM or Flash).

Likewise, the initialisation of payment terminals such as the one sold with the reference 5100 by the company INGENICO comprises a phase where an application specific to the financial operator (subscriber equipment keeper) for whom the terminal is intended is loaded into the non-volatile memory of the terminal (typically EEPROM, EPROM, Flash or battery backed up RAM). The term “application” signifies executable code, passive parameters and keys.

The executable code, passive parameters and keys are injected into the memory in a customisation station, which receives the appliance. When the appliance is connected to the customisation station, it is presumed to be in a reference state, in other words in a given logic state.

If it is required to preserve the confidentiality of the information injected into the appliance by the customisation station, it is vital to ensure that the appliance to be customised is void of any malicious applications. A malicious application is defined, for the purposes of the present patent application, as any executable code and/or passive data different from the reference state the appliance is presumed to be in.

We give here a few examples of malicious applications in various fields:
an empty payment terminal is manipulated by a malicious employee who loads onto it an application that simulates the behaviour of a blank terminal. This application leaves a copy of the secret keys in a readable field of the non-volatile memory. Once the keys have been injected, the malicious employee takes possession of the injected keys, using the copy made in a readable field of the memory. The malicious employee then deletes the application that simulates the behaviour of a blank terminal and re-programs the stolen keys correctly in a blank terminal which he reintegrates into the supply chain; monitoring the number of terminals does not allow the manipulation to be detected. The subscriber equipment keeper will thus receive a terminal believing its keys to be protected whereas these keys are known to the malicious employee;
an identity card is manufactured in a country A on behalf of a country B. Country B customises these cards, by injecting secret keys into a field of the card memory which cannot be read from outside. The card delivered to B may comprise a malicious code injected by the authorities of country A before the blank cards are delivered to country B. This code being able to simulate in relation to the customisation station perfect blank card software behaviour but to back up, in a hidden file stored in the readable memory, copies of the secret keys injected by B into the identity document. Thus, when an identity document is inspected by country A, the malicious code could be activated, and country A could thus recover the keys put into the card by country B and duplicate the identity document; the malicious code activation procedure may be highly specific, and result for example from writing in a file a specific datum that causes the malicious software to awaken;
a banker's card in which a Javacard applet comprising keys is to be inscribed may already contain a malicious code, downloaded by a dishonest operator before the card is customised. The operator could thus recover the card at the end of customisation, read back the keys, delete the malicious code, reload the legitimate code into the card (and the keys whereof he has just become cognisant) and reintegrate the card into the industrial process so that it is not missing when the final count is taken;
likewise, after a hard disk has been formatted and a Windows XP brand operating system installed upon it, it may be worth ensuring that the hard disk does in fact contain the image of the content of the Windows XP official CD marketed by the Microsoft company.

The same scenario may occur when initialising any appliance that does or does not comprise secrets (PC type computer, personal digital assistant or PDA, mobile telephone, play station, payment terminal, pay television decoder, etc.), or when injecting information such as programs, keys, and data of any kind, onto such an appliance.

It is understood that, in all these examples, it is helpful to be able to verify that the state of the appliance conforms to a reference state. This verification may be verification before information is injected into the appliance: in the examples of smart card or payment terminal customisation, the purpose of verification is to establish, prior to customisation, that the appliance conforms to the reference state, particularly the absence of any malicious application. This verification may be verification after information is injected into the appliance; the purpose of verification is then to establish that the appliance is carrying a content (executable code, parameters, passive data) that conforms strictly to a given model.

In the prior art there are three types of solution available to check that a computer appliance is carrying a logical content conforming to a given model. These solutions may involve software or hardware or be invasive.

The software solutions presume that the appliance is designed in such a way that exerting a certain physical action on the appliance will lead to guaranteed behaviour by the appliance. In the example of a PC personal computer, the physical action consisting in pressing the ctrl-alt-del keys, preceded by inserting a diskette into the drive and switching on the machine leads to the operating system starting up. When the BIOS (Basic Input/Output System) of a PC detects, on being switched on, that there is a diskette present in the diskette drive, it hands over to the program on the diskette and forces this program to run. It is thus possible to reformat an appliance that has broken down or that contains a malicious code (such as a “virus” or a “rootkit”) and said reformatting returns the appliance to a given reference state—an initialisation state, wherein the appliance is empty of logical content.

A hardware solution of this kind presumes that the appliance allows, through such a physical action, a preferred handling operation.

When it is a question of verifying that the appliance has a given logical content, such a solution presumes that the verifier is able to rewrite the desired logical content in the appliance. This is not always the case. Appliances are thus found nowadays whereof the memory is not constituted by ROM but by rewritable non-volatile memory (such as Flash memory or EEPROM). For example, several components' manufacturers offer blank Flash chips in which the card manufacturer is able to download an operating system of his choice; examples of such chips are those sold by the SST company with the reference Emosyn, by the Atmel company with the reference AT90SC3232, by the Infineon company with the reference SLE88CFX4000P, or by the Electronic Marin company with the reference EMTCG. For such appliances, the user has the possibility of loading a new operating system onto the card chip and cannot force the device to start up on an external medium, these chips do not therefore allow the user to know if the operating system embedded on the card chip does or does not conform to a given listing.

Invasive solutions presume that the appliance to be verified has been taken apart and that the element containing the code or data—the physical element providing the memory function—is inspected using an external test appliance. The external test appliance allows the memory content of the appliance for verification to be read, irrespective of the processor of the appliance for verification, and therefore irrespective of the execution of any malicious application simulating an expected operation. Once some certainty is acquired as to the conformity of the code contained in the dismantled element with the model, the element is reassembled onto the machine. By way of example, the software marketed with the reference EnCase by the Guidance Software Company allows the content of a hard disk to be audited away from a machine.

An invasive solution of this kind is often out of reach for the average user or is simply technically impossible; thus, a smart card or a payment terminal is thus designed in such a way that it is impossible to remove the slightest element from it without causing the appliance to self-destruct for security reasons.

Software solutions involve interfacing with the appliance for verification. A number of approaches are currently used but none gives any absolute certainty as to the content of the verified appliance. In all software approaches it is presumed that the attacker is entitled to impair the software (logic) state of the target machine but in no circumstances is he entitled to impair its physical structure (for example adding memory, unplugging a peripheral, replacing the disk, etc.).

A first software solution involves requesting the examined appliance to hash all or part of its memory. An approach of this kind is insufficient since it is quite easy to imagine that the malicious code has compressed the operating system (any executable code is highly redundant and therefore favourable to compression) which it decompresses and hashes as needed in order to respond to hashing requests from the verifier. Such a solution is for example described in the article “Oblivious Hashing: A Stealthy Software Integrity Verification Primitive” by Yuqun Chen, Ramarathnam Venkatesan, Matthew Cary, Ruoming Pang, Saurabh Sinha and Mariusz H. Jakubowski, Proceedings of 5^{th} International Workshop on Information Hiding, Noordwijkerhout, The Netherlands, October 2002. Lecture Notes in Computer Science, No. 2578, Springer-Verlag, 2003.

A second solution involves signing the code initially present on board the appliance for verification with a digital signature algorithm. This approach presumes that the code already present on board the appliance is trustworthy. This solution is for example advocated by the Trusted Computing Group consortium whose Internet site is http://www.trustedcomputinggroup.org/home.

### SUMMARY

An embodiment of the invention provides a solution to the problem of verifying the conformity of a computer appliance with a logical content or reference state. The embodiment of the invention only presumes knowledge of the hardware specifications of the verified appliance.

In some embodiments, the invention makes it possible to ensure that a given code is loaded exactly onto an appliance whereof the hardware specifications are known reference. These embodiments do not presume that the appliance for verification contains specific secrets, nor a code already presumed to be secure, and nor do they presume the existence of a hardware mechanism allowing the appliance to be handled in a preferred way.

In one mode of implementation, an embodiment of the invention proposes a method for verifying the conformity of the logical content of a computer appliance with a reference content, the computer appliance having a processor, a memory in which the processor can read and write, and an input/output device for interfacing the appliance processor with the outside world, the method including the following steps:
sending to the appliance a request for loading into the memory and executing a verification program P, the verification program being capable of writing data into the appliance memory and of reading data in the memory to send them to the input/output device;
sending to the appliance a request for executing the program P to saturate the memory available not taken up by the program;
exchanging messages with the appliance by executing the program and
verifying conformity of the logical content of the appliance based on the messages exchanged with the appliance.

In other embodiments, the method may have one or more of the following characteristics:
conformity is verified based on the content of the messages exchanged with the appliance;
conformity is verified based on measuring the rate over time at which messages are exchanged with the appliance;
the verification program P includes additional read instructions, causing increased activity on the input/output device;
the method includes a step of proving the verification of conformity by a backtracking technique applied to the set of instructions executable by the processor;
the step of proving conformity by a backtracking technique includes evaluating the different candidate instructions in a concrete way;
the step of proving conformity by a backtracking technique includes evaluating the different candidate instructions in an abstract way;
the method includes a step of proving the verification of conformity by an exhaustive search of possible programs applied to the set of instructions executable by the processor;
the memory load request includes a request for loading the verification program P into the memory from the input/output device;
the memory load request includes a request for the activation of a verification program P contained in the appliance;
executing the program P to saturate the available memory includes reading stuffing data from the input/output device and writing the stuffing data into the memory;
executing the program P to saturate the available memory includes reading a problem from the input/output device and resolving the problem by the verification program P using the available memory;
executing the program P to saturate the available memory includes reading a seed from the input/output device and expanding the seed using the available memory;
exchanging messages includes:

sending to the appliance a memory data read request and

receiving from the appliance data read in the memory, including the verification program code;
the verification program is capable of executing a function on memory data, and the exchange of messages includes:

sending to the appliance a function execution and memory data read request; and

receiving from the appliance the result of the function and verification program code read in the memory.
the function executed on the data includes calculating the hashing of the memory data other than the verification program code;
executing the program P to saturate the available memory includes reading a problem from the input/output device and resolving the problem using the available memory, the message exchange including:

sending to the appliance a problem; and

receiving from the appliance the result of the problem and the verification program code read in the memory.
the verification program code includes instructions for the code to be read back to the input/output device;
executing the verification program causes the deletion of the memory, with the exclusion of the verification program code.

In another embodiment, the invention proposes a method for recovering (restoring) a computer appliance that has a processor, a memory in which the processor can read and write, and an input/output device for interfacing the appliance processor with the outside world, the method including the steps of
backing up towards the outside world data present in the memory;
verifying conformity of the logical content of the computer appliance with a reference content, according to the method described above;
analysing and where appropriate processing the backed up data and
copying the analysed data into the appliance memory.

In yet another embodiment, the invention proposes a computer appliance, including a processor, a memory in which the processor can read and write, an input/output device for interfacing the appliance processor with the outside world and a verification program stored in the appliance, the verification program including instructions adapted to cause, when it is executed by the processor,
data to be written into the appliance memory and
data to be read in the memory, including the verification program code, so that they can be sent to the input/output device.

In a final embodiment, the invention proposes a computer device, including
a first sub-assembly that has a processor, a memory in which the processor can read and write, and an input/output device;
a second sub-assembly, the second sub-assembly being adapted to interface with the processor of the first sub-assembly through the input/output device and to verify conformity of the logic state of the first sub-assembly according to the aforementioned method.

### BRIEF DESCRIPTION OF THE DRAWINGS

Other characteristics and advantages will emerge from reading the following detailed description of embodiments of the invention, given solely by way of example and with reference to the drawings which show:

FIG. 1, a diagrammatic representation of an appliance, whereof it is required to verify the logic state;

FIG. 2, a flow diagram of a first implementation example of the inventive method;

FIG. 3, a flow diagram of a second implementation example of the inventive method;

FIG. 4, a flow diagram of a method for recovering the state of a computer appliance;

FIG. 5, a block diagram of a device inside which the method in FIG. 2 or 3 is implemented.

### DETAILED DESCRIPTION OF ILLUSTRATIVE EMBODIMENTS

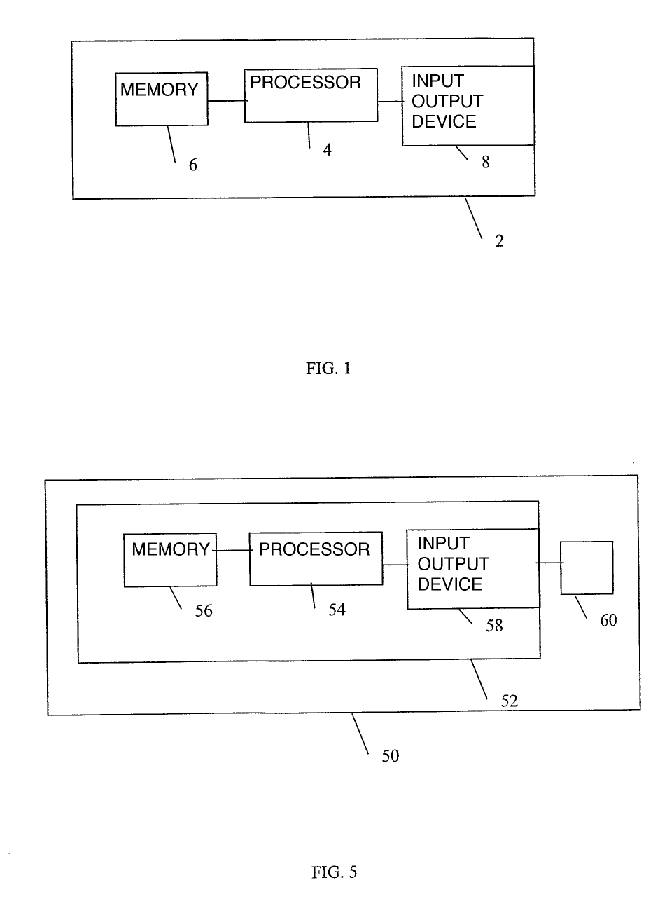

FIG. 1 shows a diagrammatic view of a computer appliance. As explained above, the appliance 2 has a processor 4, a memory 6 and an input/output device 8. The processor 4 is capable of writing into the memory 6 and reading from said memory. The processor 4 is also capable of executing executable code stored in the memory 6. The processor 4 is further capable of receiving information from the input/output device and sending information to the outside world via the input/output device. In FIG. 1 only the functional elements required to implement an embodiment of the invention have been shown; in particular, the appliance may have a specific memory containing the operating system, as in the aforementioned Flash chips for example; the memory 6 is therefore the memory offered to the appliance user so that data, parameters or executable codes can be loaded by the processor.

The different elements of the appliance in FIG. 1 are functional elements, and various hardware solutions can be used to implement them. As far as the processor is concerned, processors available on the market can be used, such as 68HC05 or 80C51, or again the aforementioned Flash chips. As far as the memory is concerned, Flash memory, a magnetic memory or an EEPROM memory of any form can be used. The particular form of the input/output device is of no concern. In the example of a smart card, the input/output device is capable of reading the signals applied to the card's serial port; in the example of a contactless smart card, the input/output device includes an antenna and the circuits adapted to decode the signals received on the antenna. In the example of a payment terminal, the different functional elements in FIG. 1 typically consist of a 32-bit micro-processor, a serial port and a Flash memory.

As indicated above, as well as a smart card or a payment terminal, the appliance may be a PC type computer or the like, a personal digital assistant, a pay television terminal, or any other appliance that has the schematic structure in FIG. 1.

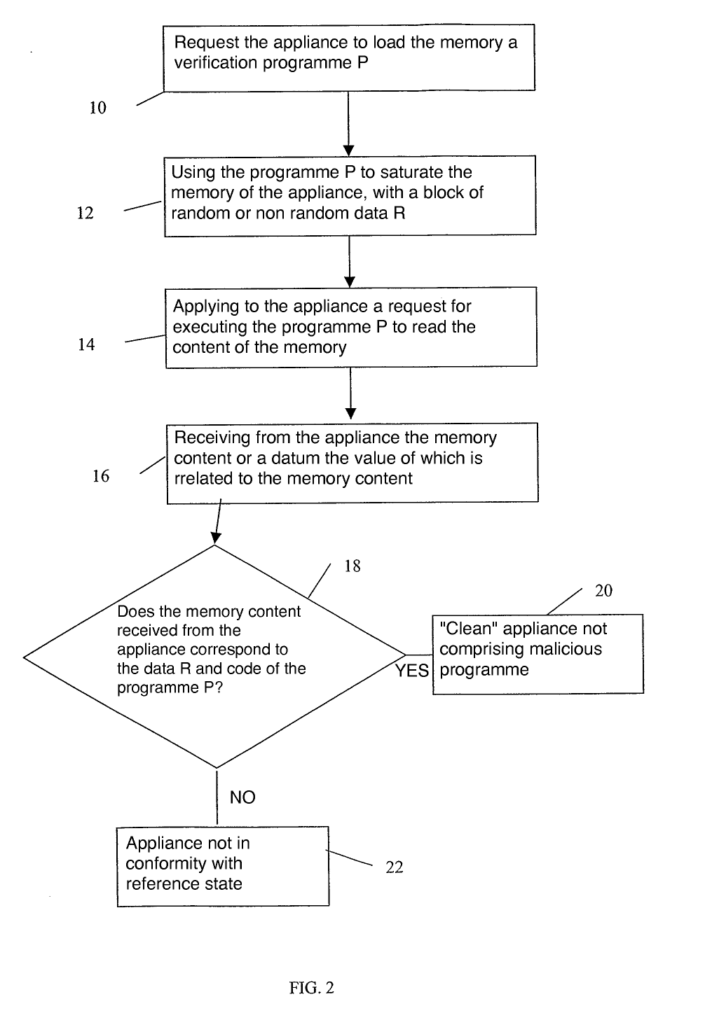

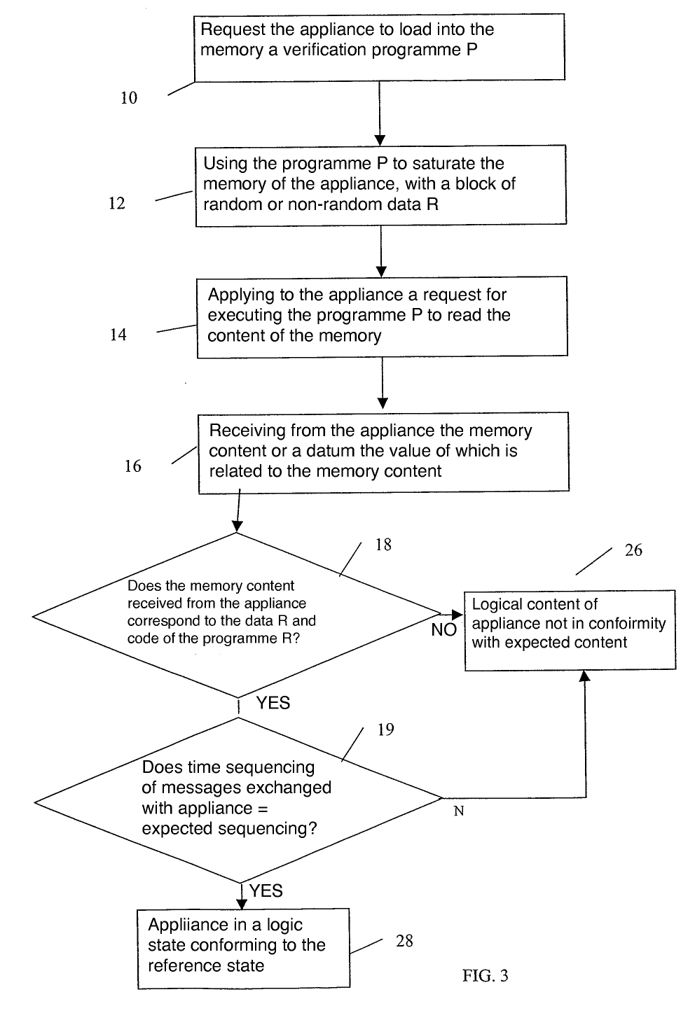

The inventive verification method presumes that the hardware specifications of the appliance 2 are known. In the example in FIG. 2, only the capacity of the appliance memory 6 needs to be known. In the example in FIG. 3, the method also requires knowledge of the time characteristics of the appliance processor, typically the number of clock cycles required to execute each instruction.

FIG. 2 is a flow diagram of a first mode of implementation of the inventive method. In this implementation mode, an embodiment of the invention exploits the fact that the execution of a malicious program, which would simulate the “normal” operation of the appliance 2, presumes that memory resources are available. An embodiment of the invention therefore proposes requesting the appliance to execute a verification program suitable for interfacing with the outside world and to saturate the appliance memory prior to the interfacing. In the absence of a malicious program, the interfacing with the outside world will occur as expected; if a malicious program is present and attempts to simulate the execution of the verification program, the absence of memory resources will mean that the interfacing with the outside world does not occur as expected.

At step 10, the appliance 2 is requested to load a verification program, denoted P hereinafter, into the memory 6 and to execute it. It may be loaded through the input/output device, by writing the program into the memory 6. A dormant verification program P —stored in the otherwise verified device—may also be provided; in this case, it is not necessary to load it through the input/output device and it has only to be fed back to the memory 6. The word “load” is therefore to be understood as covering not only writing into the program memory 6 through the input/output device 8, but also writing into the memory 6 of a program already contained in the appliance 2.

The verification program P, when it is executed, allows data to be written into the memory 6; in the embodiment described with reference to FIG. 2, data writing consists in writing into the memory 6 the data received at the input/output device 8. Other modes of writing data into the memory are given below.

The program P, when it is executed, also allows the memory content to be read so that it can be sent to the input/output device.

At the end of step 10, there is still no certainty that the appliance has correctly loaded and executed the program P. This is the case if, in the absence of any malicious program, the appliance behaves “normally”. The appliance may comprise a malicious program attempting to simulate “normal” operation: the appliance, because of this malicious program, may try to behave as if the program P had been loaded but not load it correctly or load only part of it or again refrain from executing it.

At steps 12 to 18, the program P is used to undertake a verification protocol with the appliance. The purpose of this protocol is to test appliance operation in order to be able to conclude, with certainty, that the appliance is “clean”, in other words that it does not contain any malicious program or to conclude with certainty that the program is infected, in other words that it does contain a malicious code.

At step 12, the program P is used to saturate the appliance memory 6, with a random or non-random data block, denoted R. Saturation involves filling the memory 6, except for the part of the memory 6 in which the program P is stored. In the example in FIG. 2, this saturation is effected simply by applying random data, denoted R hereinafter, to the input/output of the appliance 2; the data R are written into the memory 6 because the program P is being executed. Alternatively, it is not ruled out for R to consist of fixed and/or non-random data already present within the verified appliance or data coming from the outside world.

At steps 14 to 16, messages are exchanged with the appliance for verification. Step 14 is the application to the appliance of a request for the execution of the program P in order to read the content of the memory 6. At step 16, the content of the memory 6 or a datum whereof the value is related to the memory content is received from the appliance. We will therefore take “memory content” to mean any datum whereof the value is related and/or equal to the memory content.

At step 18, the content of the memory 6 received from the appliance 2 is compared with the expected random data R and with the code of the program P and more generally with any trace of normal execution resulting from the execution of P if the conditions were normal. If the content of the memory 6 received from the appliance corresponds to the data R and to the code of the program P, it is concluded at step 20 that the appliance is “clean” and does not include any malicious program. Conversely, if this is not the case, it is concluded at step 22 that the appliance is not in a state conforming to the reference state.

The comparison of step 18 is based on the fact that P is the only program capable both:
of holding in the space remaining in the memory after the data R is loaded and
capable of behaviour consisting in returning the data R and the P code to the outside verifier.

This fact stems on the one hand from saturating the memory 6; any malicious program present on the appliance, to simulate normal operation thereof, would have to use a part of the memory 6; it would therefore have to simulate the loading into the memory of the data R, for subsequent retrieval. As it is, this is especially difficult as the data R are random, as mentioned above, or pseudo-random. In the event of the data R not being random the verifier would have to check (prove to himself) or make an assumption that a potential malicious program is incapable of simulating the correct retrieval of these non-random data.

It next stems from the size of the program P. It is advantageous for the program P to be of the smallest size possible, to render it impossible in practice to write a program simulating its operation. In the example put forward below, the program P has a size of 23 bytes. A size of under 50 bytes constitutes in practice a small size, making it extremely difficult, if not impossible to write a program with the same operation.

It stems finally from the fact that the exchange of messages with the appliance also includes reading the code of the program P.

Thus, because of the saturation of the available memory, a malicious program program cannot have at its disposal the necessary memory resources to simulate the “normal” operation of the appliance in the different steps of the method in FIG. 2.

A first example of program P is given below. This program is written in 68HC05 assembler.

### Example 1.asm

| | | | |
|---|---|---|---|
| portA | equ | $80 | ; I/O port location |
| ddrA | equ | $81 | ; data direction register (ddr) location |
| | org | $0080 | ; program starts at address 0x80 |
| | dw | $0000 | ; initialise ddr in input mode |
| start: | clr | ddra | ; ddr in input mode upon reset |
| | ldx | portA | ; read command |
| | beq | read | ; if command is zero then read all code out |
| write: | | | ; else fill memory with incoming data |
| | lda | portA | ; read byte presented by external world |
| | sta | portA,X | ; store it at location X |
| | bra | start | ; ask for next byte |
| read: | com | ddra | ; if command nonzero make portA output |
| L1: | lda | portA,X | ; load code value, no need to set X=0 (done) |
| | sta | portA | ; send it out |
| | incx | | ; increment index |
| | bne | L1 | ; from program first byte to last |
| | bra | start | ; from program first byte to last |

| | |
|---|---|
| org $1ffE | ; |
| dw start | ; indicate to chip where program starts |

So long as the command applied is zero, the program proceeds to read the memory—including reading its own code. If the command is nonzero, the program writes in the whole available memory, outside the position it occupies. The inventive method is then implemented:
by requesting the appliance to execute loading the Example1.asm program above into its memory and then to execute it;
by applying a nonzero command and stuffing data in sufficient quantity to fill the available memory (the verifier may avoid loading of this kind as soon as he verifies that the data R already present on board are not allowing a malicious program to simulate correct behaviour—subject to such proof or such assumption data R already present on board can be used); it is recalled here that knowledge of the appliance hardware specifications is presumed, particularly the memory size;
by applying a zero command to cause all the data contained in the memory to be read.

Upon execution, this program Example1.asm will produce the sequence

00FF3F81 BE802706 B680E780 20F43381 E680B780

5C26F920 E9 {random block R}

The example offered above shows that it is possible to generate codes that have the requisite operation and revert to reading the expected information.

The method described with reference to FIG. 2 has the advantage of involving only knowledge of the capacity of the memory 6 of the appliance 2, so as to ensure memory saturation. If the time characteristics of the appliance processor 4 are also known, it is also possible to measure the time—as a number of clock cycles of the processor—needed to return the data R and the code of the program P.

The verifier is thus able to time the number of clock cycles separating the return of the different bytes composing the returned “R and P code” datum and conclude that the appliance M is “clean” only if the bytes of the “R and P code” datum are returned at the expected rate, given the specifications of the processor of the appliance M.

FIG. 3 shows the corresponding method; FIG. 3 is identical to FIG. 2, with the exception of step 19, for verifying the rate at which the messages are exchanged with the appliance. If the message timing is not as expected, the verifier concludes at step 26 that the logical content of the appliance does not conform to the expected content. Otherwise, the appliance is in a logic state conforming to the reference state (step 28). In the representation in FIG. 3, step 19 for verifying the timing of the messages exchanged with the appliance follows step 18. It is simply a diagrammatic representation, the order of verifications being irrelevant.

This verification of exchange timing makes it even more difficult for a malicious program to simulate the behaviour of the program P.

Furthermore, it is possible to prove formally through the use of a so-called backtracking technique that a given code is alone capable of retrieving R and its own code for the verifier within a precise time period and/or rate. This backtracking technique is known per se by the man skilled in the art and is described for example in: http://www.cis.upenn.edu/˜matuszek/cit594-2002/Pages/backtracking.html; and it is therefore not described in any more detail. While the certainty of conformity is empirical in the method in FIG. 2, the method in FIG. 3 allows a formal demonstration of the impossibility of supplying a malicious program simulating the operation of the verification program P.

To facilitate said proof, it is advantageous to strew the read back loop with additional instruction bytes for the return of bytes for the purpose of further constraining any malicious program, as illustrated in the following example:

| | | | | |
|---|---|---|---|---|
| L1: | LDA | PORTA,X | ; LOAD CODE VALUE | 4 CYCLES |
| | STA | PORTA | ; SEND IT OUT | 4 CYCLES |
| | INCX | | ; INCREMENT INDEX | 3 CYCLES |
| | BNE | L1 | ; | 3 CYCLES |

The preceding code fragment returns one byte every 14 machine cycles. The formal demonstration usable in the method in FIG. 3 consists in proving that no sequence of instructions of 14 cycles at most is capable of generating the expected sequence in due course.

To make it even more difficult to implement a malicious program—or to simplify the formal demonstration, it is further possible to strew the read back loop with feedback operations so as to reduce this duration of 14 cycles separating the sending of successive characters of the “R and P code” sequence as much as possible. For example:

| | | | | |
|---|---|---|---|---|
| L1: | COM | PORTA | ; AMELIORATION DELAIS | 5 CYCLES |
| | LDA | PORTA,X | ; LOAD CODE VALUE | 4 CYCLES |
| | STA | PORTA | ; SEND IT OUT | 4 CYCLES |
| | INCX | | ; INCREMENT INDEX | 3 CYCLES |
| | STX | PORTA | ; AMELIORATION DELAIS | 4 CYCLES |
| | BNE | L1 | ; | 3 CYCLES |

In this example, it will be noted that the malicious program no longer has 8, 7 or 8 cycles to generate each of the bytes the “R and P code” sequence. This allows the sequence generating codes to be explored in an automated way and these codes to be screened one after another using a so-called backtracking method, insofar as it is required to have a formal verification of the impossibility of constructing a malicious code.

It will be noted that an exhaustive search of all possible codes is not involved since as soon as a code C departs from the imposed time constraints all the longer codes that have C as a fragment or prefix are eliminated.

It is possible, for verification by backtracking, to evaluate the different candidate instructions in a concrete or abstract (symbolic) way. The advantages of a concrete evaluation are greater programming facility. The advantages of a symbolic verification are greater efficiency despite greater programming complexity.

Appendix 1 to the present description sets out the source code of a code proving procedure that allows a backtracking method specially adapted to an embodiment of the present invention.

Appendix 2 to the present description gives, for the Example1.asm program example strewn with additional read instructions, the behaviour expected by the appliance.

The proof of verification of conformity may use an exhaustive search applied to the set of instructions executable by the verified platform; all possible codes of the requisite size are then determined and the next step is to test these codes in order to prove that they are not adapted to supply the messages exchanged with the appliance; this proof is applied to the method in FIG. 2, wherein verification occurs based on the content of the messages exchanged with the appliance; this technique further applies to the method in FIG. 3, wherein verification also occurs based on measuring the rate over time at which messages are exchanged the appliance.

Appendices 3 and 4 show the encodings of the different 7 cycles and 8 cycles instructions that are possible for a set of instructions corresponding to the 68HC05 assembler. These different 7 and 8 cycles instructions can be used to prove verification of conformity by exhaustive search, when the program is strewn with read back instructions leading to 7 or 8 cycles available for the malicious program, as in the example proposed earlier.

Appendix 5 shows another example of the code of the verification program P; the appendix shows only the part of the program that allows values to be read back, the part for the placement of value in the verified memory having been removed in the interests of greater clarity.

The methods proposed with reference to FIGS. 2 and 3 allow a verification of conformity of the logical content of the appliance. These methods however involve memory saturation, by application to the input/output device of the saturation data R. A solution of this kind poses no particular problem when the capacity of the memory 6 is sufficiently small, relative to the flow rate of the input/output device. The methods in FIGS. 2 and 3 are therefore easily usable for appliances such as smart cards. If the memory capacity is too big—for example a memory in megabytes or gigabytes on a computer, one of the following solutions may be used to advantage for the memory saturation step.

A first solution consists in providing the appliance, instead and in place of saturation data, with the terms of a problem to be resolved, the resolution of the problem leading to memory saturation. As an example of such problems, mention may be made of so-called SPACE-COMPLETS problems. For example such problems are cited in the article “Moderately Hard, Memory-bound Functions” by Martin Abadi, Mike Burrows, Mark Manasse and Ted Wobber or in the article “On Memory-Bound Functions for Fighting Spam” by Cynthia Dwork, Andrew Goldberg and Moni Naor.

The problem worked on in the second article involves the calculation of collisions, and therefore the occupation of a memory capacity whereof the size can be fixed as the function of a parameter. The terms of the problem measure only a few bytes. It is understood that the terms of the problem are “short”, in relation to the size of the memory 6.

A second solution consists in applying to the appliance a short seed of a datum to be expanded by the program P, the expanded datum allowing the memory to be saturated. The expansion process is preferably such that there is no means of expanding the datum other than by taking up the whole of the available memory.

It is also possible to combine the different solutions proposed above and with reference to FIG. 2.

A third solution consists in not saturating the memory and working with data already present on board the verified platform (these data being able to be, depending on circumstances, executable code already present on board (legitimate applications code) and/or legitimate passive data). In this case, the verifier may preferably beforehand prove or presume that the retrieval of these data already present on board the platform verified by the program P during the verification phase cannot be simulated by a malicious program (with or without time sequencing constraints). Such a proof is always possible to obtain by a backtracking technique.

These solutions make it possible to limit the duration of the step of memory saturation by the program P or avoid the reloading of data already present on board. In situations where the saturation data come, at least initially, from the outside world (supplying the problem, supplying the seed), it remains impossible for a malicious program to anticipate the solution in advance and thereby avoid memory saturation. These solutions however presume that the program P is more complex than the Example1.asm program proposed earlier.

Let us note finally, that instead and in place of random memory it is also possible to use instead of R a fixed and non-confidential datum and in this case to prove that the behaviour of the platform can be characterised without ambiguity.

The methods in FIGS. 2 and 3 also involve a step 16 of reading the memory content. As with writing into the memory, the solution poses no particular problem when the capacity of the memory 6 is sufficiently small, relative to the flow rate of the input/output device. One of the following solutions may nonetheless be used in order to make the exchange between the appliance and the external world faster.

A first solution consists in proceeding, instead of reading the random or pseudo-random saturation data, to a hashing calculation or a CRC calculation in respect of this data. Insofar as the data are random or pseudo-random, the compression mentioned in the description of the prior art software solution is impossible or very difficult.

The following solution may also be proposed: n random or pseudo-random stuffing blocks are received from the outside world; these data are placed in the memory 6 by the program P. This memory saturation step 12 is followed by an indication by the outside world of a permutation of the n elements and by the return by the program P of the hash of the data permuted in the outside world. Thus, even if the malicious program knows the type of hashing to be applied, it is impossible for it to calculate the hash when receiving the stuffing blocks.

These solutions allow the duration of the step of reading from the memory by the program P to be limited. Insofar as calculating the CRC, the hash or calculating the result involves having the saturation data available in its entirety, it remains impossible for a malicious program to anticipate the solution in advance and thereby avoid memory saturation. Feedback to the outside world is however faster, since it is sufficient to transmit {the result of the calculation on the data R+the P code} instead of transmitting {the data R+the P code}.

The different solutions put forward above and with reference to FIG. 2 can also be combined. It is also understood that it is possible to mix the solutions limiting the duration of writing in the memory and the solutions limiting the duration of reading data from the memory.

Neither the continuation of the verification method nor its applications are described here. In the example of appliances for customisation, a verification of conformity of the appliance is followed by customisation, whereas an appliance proving not to conform is rejected. Once the appliance is verified, the capacity of the program P to write in the appliance memory 6 can be used for customisation.

The method in FIGS. 2 and 3 is applied particularly when the memory is not presumed to contain code or when the memory contains a known code that can be reset without difficulty at the end of the verification method.

It is also possible to make provision for the program P to start by deleting from the memory all the data present, with the exclusion of its own code and then start receiving data from the outside world.

It is also possible to make provision for the program P to leave the present data in place, but for it to communicate them to the verifier who will show that it is possible to conduct the test unambiguously with these data instead and in place of the random data.

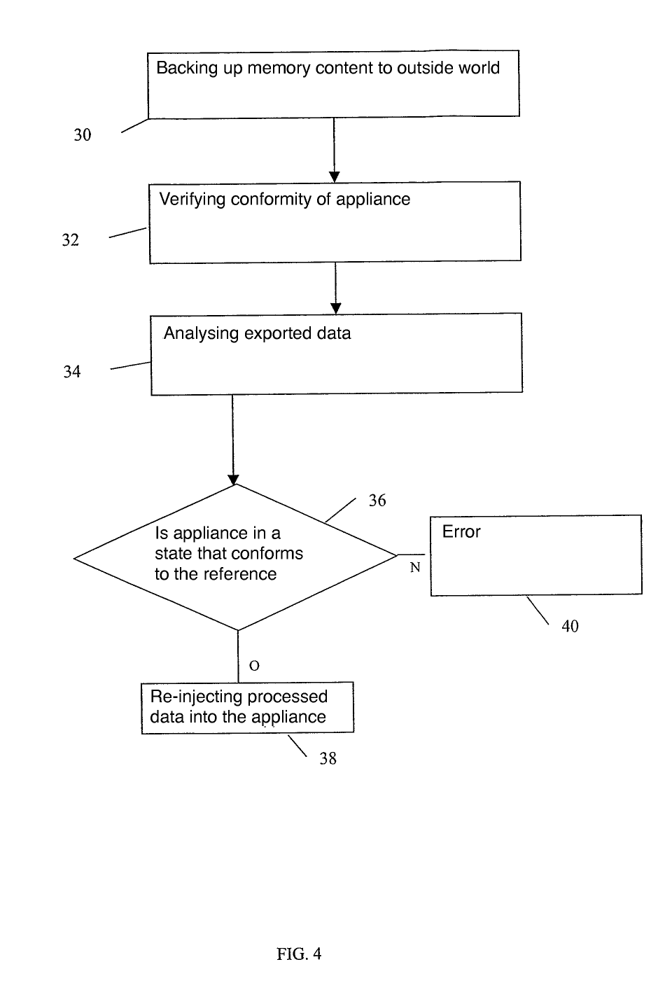

Provision may also be made, prior to the memory saturation step, for the data contained in the memory—or a part thereof to be backed up by temporarily transmitting this data to the outside world. The conformity of the backed up data may be analysed outside the appliance; the backed up data, if they do conform, may then be reset in the verified appliance; once again, the program P can be used to restore the data at the end of the conformity verification. An embodiment of the invention then allows a computer appliance to be recovered (restored). FIG. 4 shows such a method, applied to an appliance of the type in FIG. 1: the first step 30 is a step of backing up the memory content towards the outside world; it is followed by a step 32 of verifying conformity, according to the method described earlier; at step 34, the exported data are analysed and, where appropriate they are processed, if for example they contain a malicious program. If the appliance is in a state conforming to the reference state (step 36), the processed data are re-injected therein (step 38). If the verified appliance is not in a state conforming to the reference state, an error is signalled (step 40); the necessary corrective measures may then be taken (re-initialisation or the like).

It is also possible to modify the method described in an embodiment of the present invention or to bring it into more widespread use in the following ways:
a first generalisation consists, instead of writing the data R in one go and reading them back in one go, in alternating writing and reading repeatedly. Thus a first data block R[1] would be written, a first block R′[1] would be read back, and then a second data block R[2] would be written, and a second block R′[2] would be read back and so on. Here R′[i] denotes either a value which must be equal to R[i] or a value which is a function of R[i].
a second alternative may be to repeat the verification protocol with the machine several times and to accept the machine as clean only in the event of success in all protocol sessions. The purpose of such a repetition is to reduce exponentially the probability of a malicious application getting past the protocol out of pure chance.
a third alternative replaces proof by backtracking with any other form of proof, for example exhaustive search for (or construction of) the smallest code (let us call the size of this code m) capable of retrieving a datum of the size of R less m bytes.

With reference to FIGS. 2 and 3 a description has been given of verifying an appliance from the outside world, with reference to a “verifier” not belonging to the appliance. The inventive method also applies to the inside of one and the same device, between two circuits, two sub-systems or two components belonging to the device; in this case, one of the two circuits, sub-systems or components behaves like the “outside world” or like the “verifier” for the other circuit, sub-system or component. This other circuit, sub-system or component then behaves like the appliance for verification described earlier: it must therefore include a processor, a memory, and an input/output device for interfacing with the other sub-assembly. FIG. 5 shows such a device 50. The elements of the first sub-assembly are identified by the reference numbers in FIG. 1, augmented by 50. The second sub-assembly is given the reference number 60; it is not described in any more detail.

In other words, the method mentioned earlier is executed in a manner internal to the device. This may be conducted between two sub-assemblies of the device or between more than two sub-assemblies, depending on the permutations required; the method may be executed invisibly for the user of the device, periodically or in particular circumstances. In the event of non-conformity, one or more actions may then be prompted, such as for example shutting down the device functions, or a message to the user or to the outside world.

By way of example, the inventive method could be used in a multi-processor machine, such as a PC, a payment terminal, a pay television decoder, an electronic element embedded on a weapon or military vehicle, each of the processors constituting the “external world” in terms of verifying the other processor.

### APPENDIX 1

### Backtracking Algorithm Written in Mathematica Language

The algorithm explores codes of size MSZ=21 bytes (for example) and presumes a set of instructions 68HC05 restricted to the instructions INCA, LDA, STA and BNE, input port at 0x00, output port at 0x01

q:=Function[x,Mod[x,256]];
MSZ=21;
s:=Function[x,Mod[x,MSZ]];
(* this function initialises the memory state at —1 (−1 signifying by convention value
unspecified) except the port at the address 0 which is initialised at 0*)
M=Prepend[Table[−1,{n,1,MSZ−1}],0];|
(*values of 4 opcodes*)
BNE=16\hat{ }\hat{ }26: LDA=16\hat{ }\hat{ }B6; INC=16\hat{ }\hat{ }4C; STA=16\hat{ }\hat{ }B7;|
(*function returning the content of a memory box*) RM:=Function[x,M[[s[x]+1]]];
(*function assigning a value to a memory box*)
SM:=Function[{x,v],M[[s[x]+1]]=v];|
(*function verifying compatibility of the machine content with a code hypothesis made
by the backtracking algorithm*)
NC:=Function[{pt,1st},Sum[If[1st[[d+1]≠ RM[s[pt+d]]&& RM[s[pt+d]]≠−1
,1,0],{d,0,Length[1st]−1}]≠0];
(*function assigning a value series to the memory*)
SetM:=Function[{pt,v1},For[b=1,b≦ Length[v1],SM[s[pt+b−1],v1[[s[b]]]];b++]];|
(*function assigning values to the microprocessor registers*)
SetRegs:=Function[{va,pt},A=q[va];Z=If[A 0,1,0];PC=s[pt];SM[1,A]];|
(*function for decoding relative pathnames for the jump instruction*)
dec:=Function[j,2+j−If[j≦ 16\hat{ }\hat{ }7F,0,256]];
(*function testing whether the memory state is compatible with the assumption of
instruction fragment of the form INCA STA 1*)
INCT:=Function[U,q[Ex−1]≠|A∥NC[PC,{INC,STA,1}]]
(*modelling the effect of an instruction fragment of type INCA STA 1*)
INCS:=Function[U,SetM[PC,{INC,STA,1}];A=Ex;Z=If[A 0,1,0];PC=s[PC+3]; SM[1,A];]
(*same procedure as before for a fragment of type LDA m STA 1*)
LDAT:=Function[U,

NC[PC,{LDA,U,STA,1}]∥

If[MemberQ[{PC,s[PC+1],s[PC+2],s[PC+3]},s[U]],

Ex≠

Pick[{LDA,U,STA,1},{PC,s[PC+1],s[PC+2],s[PC+3]},s[U]][[1]],

RM[U]≠Ex && RM[U]≠−1 ]];

LDAS:=Function[U,
SetM[PC,{LDA,U,STA,1}];
If [Not[MemberQ[{PC,s[PC+1],s[PC+2],s[PC+3]},s[U]]] ,SM[U,Ex]];
A=RM[U];Z=If[A 0,1,0];PC=s[PC+4]; SM[1,A];]
(*modelling the effect of an instruction fragment of type BNE Lable STA 1*)
BRAT:=Function[L,(Ex≠ A|[NC[PC,{BNE,L}]) ∥

If[Z==1,NC[s[PC+2],{STA,1}],

NC[s[PC+dec[L]],{STA,1}]∥16\hat{ }\hat{ }FE≦ L≦ 16\hat{ }\hat{ }FF]] ;
BRAS:=Function[L,

SetM[PC,{BNE,L}];
SetM[If[Z 1,s[PC+2],s[PC+dec[L]]],{STA,1}];
Z=If[A 0,1,0];A=Ex;SM[1,A];PC=s[PC+If[Z 1,4,dec[L]+2]]] ;

(*modelling the effect of an instruction fragment of type STA m STA 1*)
STAT:=Function[U,

NC[PC,{STA,U,STA,1}] ∥ A≠Ex ∥ s[U]==1 ∥ (s[U] s[PC+2] && A≠STA) ∥

(s[U] s[PC+1] && A≠1)];
STAS:=Function[U,

SetM[PC,{STA,U,STA,1}];
SM[U,Ex]: Z=If[A 0,1,0];A=Ex;PC=s[PC+4];SM[1,Ex];];

(*reading the file containing the expected values of a legitime platform and their
sequencing over time, file given below*)
ExList=Drop[Drop[<<file.m,1],1];
(*reading the files containing all the fragments whereof the execution may take 7 or 8
cycles, files given below*)
Try[7]=<<try7.txt;Try[8]=<<try8.txt;S[8]=Length[Try[8]];S[7]=Length[Try[7]];
(*Isolating the expected values in a table EV=Expected Values and time sequencing
values TM=Timing*)
TM=Table[ExList[[h,2]],{h,1,Length[ExList]}];
EV=Table[ExList[[h,1]],{h,1,Length[ExList]}];
(*Initialisating a GS list containing the state of the hypothesis explored*)
For[h=1,h≦ Length[ExList],GS[h]=1;PL[h]=0;h++];|
(*this function generates the state corresponding to a given GS list*)
ReRun:=Function[idd, PC=PCx;A=Ax;Z=Zx;M=Prepend[Table[−1,{n,1,MSZ−1}],0];
For[c=1,c≦idd, Ex=EV[[c]]; ExecInst[Try[TM[[c]]][[ GS[c]]]]; c++]];
(*function translating an instruction into a test function*)
TestInst:=Function[hy,Pick[{INCT,LDAT,BRAT,STAT},{“INC”,“LDA”,“BRA”,“STA”},hy[
[1]]][[1]][hy[[2]]]]
(*function translating an instruction into an execution function*)
ExecInst:=Function[hy,Pick[{INCS,LDAS,BRAS,STAS},{“INC”,“LDA”,“BRA”,“STA”},hy[
[1]]][[1]][hy[[2]]]]
(*carry run function on the code fragment indexes*)
Uniformize:=Function[,For[h=Length[ExList],h≠1,
If[GS[h] S[TM[[h]]] +1,GS[h−1]++;GS[h]=1]; h−−]];
(*backtracking loop*)
For[Zx=1, Zx≦ 2,For[Ax=0,Ax≦ 255,For[PCx=8,PCx≦ MSZ−1,

(****************)
PC=PCx; A=Ax; Z=Zx;
ID=1; Label[yyy]; Ex=EV[[ID]];CY=TM[[ID]]; HY=Try[CY][[GS[ID]]];
If[Not[TestInst[HY]] , ExecInst[HY]; ID++;Goto[yyy],

If[GS[ID]<S[CY],GS[ID]++; Goto[yyy]]];

PL[ID−1]++; GS[ID]=1; GS[ID−1]++;ID−−; Uniformize[ ]; ReRun[ID−1];
Goto[yyy]; Label[zzz];
(****************)
PCx++];Ax++];Zx++];

### APPENDIX 2

### Encoding the Behaviour Expected by the Platform

### File file.m

{{0,4}, {0,7}, {0,7}, {1,7}, {1,8}, {1,7}, {1,7}, {1,7}, {2,7}, {2,8}, {2,7}, {183,7}, {2,7}, {3,7}, {3,8}, {3,7}, {1,7}, {3,7}, {4,7}, {4,8},
{4,7}, {182,7}, {4,7}, {5,7}, {5,8}, {5,7}, {5,7}, {5,7}, {6,7}, {6,8}, {6,7}, {183,7}, {6,7}, {7,7}, {7,8}, {7,7}, {1,7}, {7,7}, {8,7}, {8,8},
{8,7}, {182,7}, {8,7}, {9,7}, {9,8}, {9,7}, {5,7}, {9,7}, {10,7}, {10,8}, {10,7}, {183,7}, {10,7}, {11,7}, {11,8}, {11,7}, {1,7}, {11,7}, {12,7},
{12,8}, {12,7}, {76,7}, {12,7}, {13,7}, {13,8}, {13,7}, {183,7}, {13,7}, {14,7}, {14,8}, {14,7}, {1,7}, {14,7}, {15,7}, {15,8}, {15,7}, {183,7},
{15,7}, {16,7}, {16,8}, {16,7}, {5,7}, {16,7}, {17,7}, {17,8}, {17,7}, {183,7}, {17,7}, {18,7}, {18,8}, {18,7}, {1,7}, {18,7}, {19,7}, {19,8},
{19,7}, {38,7}, {19,7}, {20,7}, {20,8}, {20,7}, {237,7}, {20,7}, {21,7}, {21,8}, {21,7}, {9,7}, {21,7}, {22,7}, {22,8}, {22,7}, {22,7}, {22,7},
{23,7}, {23,8}, {23,7}, {183,7}, {23,7}, {24,7}, {24,8}, {24,7}, {1,7}, {24,7}, {25,7}, {25,8}, {25,7}, {182,7}, {25,7}, {26,7}, {26,8}, {26,7},
{26,7}, {26,7}, {27,7}, {27,8}, {27,7}, {183,7}, {27,7}, {28,7}, {28,8}, {28,7}, {1,7}, {28,7}, {29,7}, {29,8}, {29,7}, {182,7}, {29,7}, {30,7},
{38,8}, {30,7}, {5,7}, {30,7}, {31,7}, {31,8}, {31,7}, {183,7}, {31,7}, {32,7}, {32,8}, {32,7}, {1,7}, {32,7}, {33,7}, {33,8}, {33,7}, {76,7},
{33,7}, {34,7}, {34,8}, {34,7}, {183,7}, {34,7}, {35,7}, {35,8}, {35,7}, {1,7}, {35,7}, {36,7}, {36,8}, {36,7}, {183,7}, {36,7}, {37,7}, {37,8},
{37,7}, {5,7}, {37,7}, {38,7}, {38,8}, {38,7}, {183,7}, {38,7}, {39,7}, {39,8}, {39,7}, {1,7}, {39,7}, {40,7}, {40,8}, {40,7}, {38,7}, {40,7},
{41,7}, {41,8}, {41,7}, {237,7}, {41,7}, {42,7}, {42,8}, {42,7}, {0,7}, {42,7}, {43,7}, {43,8}, {43,7}, {43,7}, {43,7}, {44,7}, {44,8}, {44,7},
{183,7}, {44,7}, {45,7}, {45,8}, {45,7}, {1,7}, {45,7}, {46,7}, {46,8}, {46,7}, {182,7}, {46,7}, {47,7}, {47,8}, {47,7}, {47,7}, {47,7}, {48,7},
{48,8}, {48,7}, {183,7}, {48,7}, {49,7}, {49,8}, {49,7}, {1,7}, {49,7}, {50,7}, {50,8}, {50,7}, {182,7}, {50,7}, {51,7}, {51,8}, {51,7}, {5,7},
{51,7}, {52,7}, {52,8}, {52,7}, {183,7}, {52,7}, {53,7}, {53,8}, {53,7}, {1,7}, {53,7}, {54,7}, {54,8}, {54,7}, {76,7}, {54,7}, {55,7}, {55,8},
{55,7}, {183,7}, {55,7}, {56,7}, {56,8}, {56,7}, {1,7}, {56,7}, {57,7}, {57,8}, {57,7}, {183,7}, {57,7}, {58,7}, {58,8}, {58,7}, {5,7}, {58,7},
{59,7}, {59,8}, {59,7}, {183,7}, {59,7}, {60,7}, {60,8}, {60,7}, {1,7}, {60,7}, {61,7}, {61,8}, {61,7}, {38,7}, {61,7}, {62,7}, {62,8}, {62,7},
{237,7}, {62,7}, {63,7}, {63,8}, {63,7}, {0,7}, {63,7}, {64,7}, {64,8}, {64,7}, {64,7}, {64,7}, {65,7}, {65,8}, {65,7}, {183,7}, {65,7}, {66,7},
{66,8}, {66,7}, {1,7}, {66,7}, {67,7}, {67,8}, {67,7}, {182,7}, {67,7}, {68,7}, {68,8}, {68,7}, {68,7}, {68,7}, {69,7}, {69,8}, {69,7}, {183,7},
{69,7}, {70,7}, {70,8}, {70,7}, {1,7}, {70,7}, {71,7}, {71,8}, {71,7}, {182,7}, {71,7}, {72,7}, {72,8}, {72,7}, {5,7}, {72,7}, {73,7}, {73,8},
{73,7}, {183,7}, {73,7}, {74,7}, {74,8}, {74,7}, {1,7}, {74,7}, {75,7}, {75,8}, {75,7}, {76,7}, {75,7}, {76,7}, {76,8}, {76,7}, {183,7}, {76,7},
{77,7}, {77,8}, {77,7}, {1,7}, {77,7}, {78,7}, {78,8}, {78,7}, {183,7}, {78,7}, {79,7}, {79,8}, {79,7}, {5,7}, {79,7}, {80,7}, {80,8}, {80,7},
{183,7}, {80,7}, {81,7}, {81,8}, {81,7}, {1,7}, {81,7}, {82,7}, {82,8}, {82,7}, {38,7}, {82,7}, {83,7}, {83,8}, {83,7}, {237,7}, {83,7}, {84,7},
{84,8}, {84,7}, {0,7}, {84,7}, {85,7}, {85,8}, {85,7}, {85,7}, {85,7}, {86,7}, {86,8}, {86,7}, {183,7}, {86,7}, {87,7}, {87,8}, {87,7}, {1,7},
{87,7}, {88,7}, {88,8}, {88,7}, {182,7}, {88,7}, {89,7}, {89,8}, {89,7}, {89,7}, {89,7}, {90,7}, {90,8}, {90,7}, {183,7}, {90,7}, {91,7}, {91,8},
{91,7}, {1,7}, {91,7}, {92,7}, {92,8}, {92,7}, {182,7}, {92,7}, {93,7}, {93,8}, {93,7}, {5,7}, {93,7}, {94,7}, {94,8}, {94,7}, {183,7}, {94,7},
{95,7}, {95,8}, {95,7}, {1,7}, {95,7}, {96,7}, {96,8}, {96,7}, {76,7}, {96,7}, {97,7}, {97,8}, {97,7}, {183,7}, {97,7}, {98,7}, {98,8}, {98,7},
{1,7}, {98,7}, {99,7}, {99,8}, {99,7}, {183,7}, {99,7}, {100,7}, {100,8}, {100,7}, {5,7}, {100,7}, {101,7}, {101,8}, {101,7}, {183,7}, {101,7},
{102,7}, {102,8}, {102,7}, {1,7}, {102,7}, {103,7}, {103,8}, {103,7}, {38,7}, {103,7}, {104,7}, {104,8}, {104,7}, {237,7}, {104,7}, {105,7},
{105,8}, {105,7}, {0,7}, {105,7}, {106,7}, {106,8}, {106,7}, {106,7}, {106,7}, {107,7}, {107,8}, {107,7}, {183,7}, {107,7}, {108,7}, {108,8},
{108,7}, {1,7}, {108,7}, {109,7}, {109,8}, {109,7}, {182,7}, {109,7}, {110,7}, {110,8}, {110,7}, {110,7}, {110,7}, {111,7}, {111,8}, {111,7},
{183,7}, {111,7}, {112,7}, {112,8}, {112,7}, {1,7}, {112,7}, {113,7}, {113,8}, {113,7}, {182,7}, {113,7}, {114,7}, {114,8}, {114,7}, {5,7},
{114,7}, {115,7}, {115,8}, {115,7}, {183,7}, {115,7}, {116,7}, {116,8}, {116,7}, {1,7}, {116,7}, {117,7}, {117,8}, {117,7}, {76,7}, {117,7},
{118,7}, {118,8}, {118,7}, {183,7}, {118,7}, {119,7}, {119,8}, {119,7}, {1,7}, {119,7}, {120,7}, {120,8}, {120,7}, {183,7}, {120,7}, {121,7},
{121,8}, {121,7}, {5,7}, {121,7}, {122,7}, {122,8}, {122,7}, {183,7}, {122,7}, {123,7}, {123,8}, {123,7}, {1,7}, {123,7}, {124,7}, {124,8},
{124,7}, {38,7}, {124,7}, {125,7}, {125,8}, {125,7}, {237,7}, {125,7}, {126,7}, {126,8}, {126,7}, {0,7}, {126,7}, {127,7}, {127,8}, {127,7},
{127,7}, {127,7}, {128,7}, {128,8}, {128,7}, {183,7}, {128,7}, {129,7}, {129,8}, {129,7}, {1,7}, {129,7}, {130,7}, {130,8}, {130,7}, {182,7},
{130,7}, {131,7}, {131,8}, {131,7}, {131,7}, {131,7}, {132,7}, {132,8}, {132,7}, {183,7}, {132,7}, {133,7}, {133,8}, {133,7}, {1,7}, {133,7},
{134,7}, {134,8}, {134,7}, {183,7}, {134,7}, {135,7}, {135,8}, {135,7}, {5,7}, {135,7}, {136,7}, {136,8}, {136,7}, {183,7}, {136,7}, {137,7},
{137,8}, {137,7}, {1,7}, {137,7}, {138,7}, {138,8}, {138,7}, {76,7}, {138,7}, {139,7}, {139,8}, {139,7}, {183,7}, {139,7}, {140,7}, {140,8},
{140,7}, {1,7}, {140,7}, {141,7}, {141,8}, {141,7}, {183,7}, {141,7}, {142,7}, {142,8}, {142,7}, {5,7}, {143,7}, {143,7}, {143,8}, {143,7},
{183,7}, {143,7}, {144,7}, {144,8}, {144,7}, {1,7}, {144,7}, {145,7}, {145,8}, {145,7}, {38,7}, {145,7}, {146,7}, {146,8}, {146,7}, {237,7},
{146,7}, {147,7}, {147,8}, {147,7}, {0,7}, {147,7}, {148,7}, {148,8}, {148,7}, {148,7}, {148,7}, {149,7}, {149,8}, {149,7}, {183,7}, {149,7},
{150,7}, {150,8}, {150,7}, {1,7}, {150,7}, {151,7}, {151,8}, {151,7}, {182,7}, {151,7}, {152,7}, {152,8}, {152,7}, {152,7}, {152,7}, {153,7},
{153,8}, {153,7}, {183,7}, {153,7}, {154,7}, {154,8}, {154,7}, {1,7}, {154,7}, {155,7}, {155,8}, {155,7}, {182,7}, {155,7}, {156,7}, {156,8},
{156,7}, {5,7}, {156,7}, {157,7}, {157,8}, {154,8}, {154,7}, {1,7}, {154,7}, {155,7}, {155,8}, {155,7}, {182,7}, {155,7}, {156,7}, {156,8},
{156,7}, {5,7}, {156,7}, {157,7}, {157,8}, {157,7}, {183,7}, {157,7}, {158,7}, {158,8}, {158,7}, {1,7}, {158,7}, {159,7}, {159,8}, {159,7},
{76,7}, {159,7}, {160,7}, {160,8}, {160,7}, {183,7}, {160,7}, {161,7}, {161,8}, {161,7}, {1,7}, {161,7}, {162,7}, {162,8}, {162,7}, {183,7},
{162,7}, {163,7}, {163,8}, {163,7}, {5,7}, {163,7}, {164,7}, {164,8}, {164,7}, {183,7}, {164,7}, {165,7}, {165,8}, {165,7}, {1,7}, {165,7},
{166,7}, {166,8}, {166,7}, {38,7}, {166,7}, {167,7}, {167,8}, {167,7}, {237,7}, {167,7}, {168,7}, {168,8}, {168,7}, {0,7}, {168,7}, {169,7},
{169,8}, {169,7}, {169,7}, {169,7}, {170,7}, {170,8}, {170,7}, {183,7}, {170,7}, {171,7}, {171,8}, {171,7}, {1,7}, {171,7}, {172,7}, {172,8},
{172,7}, {182,7}, {172,7}, {173,7}, {173,8}, {173,7}, {173,7}, {173,7}, {174,7}, {174,8}, {174,7}, {183,7}, {174,7}, {175,7}, {175,8}, {175,7},
{1,7}, {175,7}, {176,7}, {176,8}, {176,7}, {182,7}, {176,7}, {177,7}, {177,8}, {177,7}, {5,7}, {177,7}, {178,7}, {178,8}, {178,7}, {183,7},
{178,7}, {179,7}, {179,8}, {179,7}, {1,7}, {179,7}, {180,7}, {180,8}, {180,7}, {76,7}, {180,7}, {181,7}, {181,8}, {181,7}, {183,7}, {181,7},
{182,7}, {182,8}, {182,7}, {1,7}, {182,7}, {183,7}, {183,8}, {183,7}, {183,7}, {183,7}, {184,7}, {184,8}, {184,7}, {5,7}, {184,7}, {185,7},
{185,8}, {185,7}, {183,7}, {185,7}, {186,7}, {186,8}, {186,7}, {1,7}, {186,7}, {187,7}, {187,8}, {187,7}, {38,7}, {187,7}, {188,7}, {188,8},
{188,7}, {237,7}, {188,7}, {189,7}, {189,8}, {189,7}, {0,7}, {189,7}, {190,7}, {190,8}, {190,7}, {190,7}, {190,7}, {191,7}, {191,8}, {191,7},
{183,7}, {191,7}, {192,7}, {192,8}, {192,7}, {1,7}, {192,7}, {193,7}, {193,8}, {193,7}, {182,7}, {193,7}, {194,7}, {194,8}, {194,7}, {194,7},
{194,7}, {195,7}, {195,8}, {195,7}, {183,7}, {195,7}, {196,7}, {196,8}, {196,7}, {1,7}, {196,7}, {197,7}, {197,8}, {197,7}, {182,7}, {197,7},
{198,7}, {198,8}, {198,7}, {5,7}, {198,7}, {199,7}, {199,8}, {199,7}, {183,7}, {199,7}, {200,7}, {200,8}, {200,7}, {1,7}, {200,7}, {201,7},
{201,8}, {201,7}, {76,7}, {201,7}, {202,7}, {202,8}, {202,7}, {183,7}, {202,7}, {203,7}, {203,8}, {203,7}, {1,7}, {203,7}, {204,7}, {204,8},
{204,7}, {183,7}, {204,7}, {205,7}, {205,8}, {205,7}, {5,7}, {205,7}, {206,7}, {206,8}, {206,7}, {183,7}, {206,7}, {207,7}, {207,8}, {207,7},
{1,7}, {207,7}, {208,7}, {208,8}, {208,7}, {38,7}, {208,7}, {209,7}, {209,8}, {209,7}, {237,7}, {209,7}, {210,7}, {210,8}, {210,7}, {0,7},
{210,7}, {211,7}, {211,8}, {211,7}, {211,7}, {211,7}, {212,7}, {212,8}, {212,7}, {183,7}, {212,7}, {213,7}, {213,8}, {213,7}, {1,7}, {213,7},
{214,7}, {214,8}, {214,7}, {182,7}, {214,7}, {215,7}, {215,8}, {215,7}, {215,7}, {215,7}, {216,7}, {216,8}, {216,7}, {183,7}, {216,7}, {217,7},
{217,8}, {217,7}, {1,7}, {217,7}, {218,7}, {218,8}, {218,7}, {182,7}, {218,7}, {219,7}, {219,8}, {219,7}, {5,7}, {219,7}, {220,7}, {220,8},
{220,7}, {183,7}, {220,7}, {221,7}, {221,8}, {221,7}, {1,7}, {221,7}, {222,7}, {222,8}, {222,7}, {76,7}, {222,7}, {223,7}, {223,8}, {223,7},
{183,7}, {223,7}, {224,7}, {224,8}, {224,7}, {1,7}, {224,7}, {225,7}, {225,8}, {225,7}, {183,7}, {225,7}, {226,7}, {226,8}, {226,7}, {5,7},
{226,7}, {227,7}, {227,8}, {227,7}, {183,7}, {227,7}, {228,7}, {228,8}, {228,7}, {1,7}, {228,7}, {229,7}, {229,8}, {229,7}, {38,7}, {229,7},
{230,7}, {230,8}, {230,7}, {237,7}, {230,7}, {231,7}, {231,8}, {231,7}, {0,7}, {231,7}, {232,7}, {232,8}, {232,7}, {232,7}, {232,7}, {233,7},
{233,8}, {233,7}, {183,7}, {233,7}, {234,7}, {234,8}, {234,7}, {1,7}, {234,7}, {235,7}, {235,8}, {235,7}, {182,7}, {235,8}, {236,7}, {236,8},
{236,7}, {236,7}, {236,7}, {237,7}, {237,8}, {237,7}, {183,7}, {237,7}, {238,7}, {238,8}, {238,7}, {1,7}, {238,7}, {239,7}, {239,8}, {239,7},
{182,7}, {239,7}, {240,7}, {240,8}, {240,7}, {5,7}, {240,7}, {241,7}, {241,8}, {241,7}, {183,7}, {241,7}, {242,7}, {242,8}, {242,7}, {1,7},
{242,7}, {243,7}, {243,8}, {243,7}, {76,7}, {243,7}, {244,7}, {244,8}, {244,7}, {183,7}, {244,7}, {245,7}, {245,8}, {245,7}, {1,7}, {245,7},
{246,7}, {246,8}, {246,7}, {183,7}, {246,7}, {247,7}, {247,8}, {247,7}, {5,7}, {247,7}, {248,7}, {248,8}, {248,7}, {183,7}, {248,7}, {249,7},
{249,8}, {249,7}, {1,7}, {249,7}, {250,7}, {250,8}, {250,7}, {38,7}, {250,7}, {251,7}, {251,8}, {251,7}, {237,7}, {251,7}, {252,7}, {252,8},
{252,7}, {0,7}, {252,7}, {253,7}, {253,8}, {253,7}, {253,7}, {253,7}, {254,7}, {254,8}, {254,7}, {183,7}, {254,7}, {255,7}, {255,8}, {255,7},
{1,7}, {255,7}, {0,7}, {0,8}}

### APPENDIX 3

### Encoding the Different 7 Cycles Instructions

### File try7.txt

{{LDA,0},{LDA,1},{LDA,2},...( insert here elements of the form
{LDA,1}) ...,{LDA,251}, {LDA,252}, {LDA,253},
{LDA,254},{LDA,255},{BRA,0},{BRA,1},{BRA,2},... insert here
elements of the form {BRA, i}) ..., {BRA,253}, {BRA,254},
{BRA,255}, {INC,0}}

### APPENDIX 4

### Encoding the Different 8 Cycles Instructions

### File try8.txt

{{STA,1},{STA,2},... insert here elements of the form {STA,
i})...,{STA,252},{STA,253},{STA,254},{STA,255}, {STA,0}}

### APPENDIX 5

| | | | |
|---|---|---|---|
| portR | equ | $00 | ; read port location |
| PortS | equ | PortR+1 | ; send port location |
| | org | portR | ; |
| | dw | $0000 | ; |
| start: | sta | portS | ; |
| addr1 | lda | portR | ; |
| | sta | portS | ; |
| | lda | addr1+1 | ; |
| | sta | portS | ; |
| | inca | | ; |
| | sta | portS | ; |
| | sta | addr1+1 | ; |
| | sta | portS | ; |
| | bne | send | ; |

| | |
|---|---|
| org S1ffE | ; |
| dw start | ; |

Although the present disclosure has been described with reference to one or more examples, workers skilled in the art will recognize that changes may be made in form and detail without departing from the scope of the disclosure and/or the appended claims.

1. Method for verifying conformity of logical content of a computer appliance with a reference content,
the computer appliance having a processor, a memory in which the processor can read and write, and an input/output device for interfacing the appliance processor with the outside world
the method including the following steps:
sending to the appliance a request to load into the memory and to execute a verification program having program code, the verification program being capable of writing data into the appliance memory and of reading data in the memory so as to send them to the input/output device;
sending to the appliance a request to execute the program to saturate the available memory not taken up by the program;
exchanging messages with the appliance executing the program; and
verifying the conformity of the logical content of the appliance based on the messages exchanged with the appliance.

2. The method according to claim 1, wherein conformity is verified based on the content of the messages exchanged with the appliance.

3. The method according to claim 1, wherein conformity is verified based on measuring a rate over time at which messages are exchanged with the appliance.

4. The method according to claim 3, wherein the verification program includes additional read instructions, prompting increased activity at the input/output device.

5. The method according to claim 1, additionally including a step of proving verification of conformity by a backtracking technique applied to a set of instructions executable by the processor.

6. The method according to claim 5, wherein the step of proving conformity by a backtracking technique includes evaluating different candidate instructions in a concrete way.

7. The method according to claim 5, wherein the step of proving conformity by a backtracking technique includes evaluating different candidate instructions in an abstract way.

8. The method according to claim 1, additionally including a step of proving verification of conformity by an exhaustive search of possible programs applied to a set of instructions executable by the processor.

9. The method according to claim 1, wherein the request to load into the memory includes a request to load the verification program into the memory from the input/output device.

10. The method according to claim 1, wherein the request to load into the memory includes a request to activate a verification program contained in the appliance.

11. The method according to claim 1, wherein executing the program to saturate the available memory includes reading stuffing data from the input/output device and writing the stuffing data into the memory.

12. The method according to claim 1, wherein executing the program to saturate the available memory includes reading a problem from the input/output device and resolving the problem by the verification program using the available memory.

13. The method according to claim 1, wherein executing the program to saturate the available memory includes reading a seed from the input/output device and expanding the seed using the available memory.

14. The method according to claim 1, wherein exchanging messages includes:
sending to the appliance a request to read data in the memory; and
receiving from the appliance data read in the memory, including the verification program code.

15. The method according to claim 1, wherein the verification program is capable of executing a function on memory data to produce a result, and wherein the message exchange includes:
sending to the appliance a request to execute the function and to read data in the memory; and
receiving from the appliance the function result and the verification code read in the memory.

16. The method according to claim 15, wherein the function includes calculating the hashing of the memory data other than the verification program code.

17. The method according to claim 1, wherein executing the program to saturate the available memory includes reading a problem from the input/output device and resolving the problem using the available memory to produce a result,
and wherein the message exchange includes:
sending to the appliance a problem; and
receiving from the appliance the problem result and the verification program code read in the memory.

18. The method according to claim 1, wherein the verification program code includes instructions for reading the code back to the input/output device.

19. The method according to claim 1, wherein executing the verification program prompts deletion of the memory, with the exclusion of the verification program code.

20. A method of recovering a computer appliance that has a processor, a memory in which the processor can read and write, and an input/output device for interfacing the appliance processor with the outside world,
the method including the steps of:
backing up to the outside world data present in the memory;
verifying conformity of a logical content of the computer appliance with a reference content, according to the method of claim 1;
analysing and, where appropriate, processing the backed up data and
copying the data analysed to the appliance memory.

21. A computer appliance, including a processor, a memory in which the processor can read and write, and input/output device for interfacing the appliance processor with the outside world and a verification program stored in the appliance, the verification program including instructions adapted to prompt, when it is executed by the processor,
writing of data into the appliance memory and
reading of data in the memory, including the verification program code, so that they can be sent to the input/output device.

22. A computer device, including
a first sub-assembly that has a processor, a memory in which the processor can read and write, and an input/output device;
a second sub-assembly, the second sub-assembly being adapted to interface with the processor of the first sub-assembly through the input/output device and to verify conformity of a logic content of the first sub-assembly with a reference content according to a method including the following steps:
sending to the first sub-assembly a request to load into the memory and to execute a verification program having program code, the verification program being capable of writing data into the memory and of reading data in the memory so as to send them to the input/output device;
sending to the first sub-assembly a request to execute the program to saturate the available memory not taken up by the program;
exchanging messages with the first sub-assembly executing the program; and
verifying the conformity of the logical content of the first sub-assembly based on the messages exchanged with the first sub-assembly.
